(19) United States
(12) Patent Application Publication
(10) Pub. No.: US 2026/0330987 A1
(43) Pub. Date: Oct. 22, 2026

(54) MACHINE-LEARNING BASED METHOD FOR ASSESSING PRESENTATIONS AND PRESENTATION ENGAGEMENT

(71) Applicants: Constructor Technology AG, Schaffhausen (CH); Constructor Education and Research Genossenschaft, Schaffhausen (CH)

(72) Inventors: Svetlana Dergacheva, Sofia (BG); Nikita Zherebtsov, Sofia (BG); Alexander Tormasov, Bremen (DE); Laurent Dedenis, Geneve (CH); Stanislav Protasov, Singapore (SG); Serg Bell, Singapore (SG); Nikolay Dobrovolskiy, Alanya (TR)

(21) Appl. No.: 19/184,317

(22) Filed: Apr. 21, 2025

(51) Int. Cl. G09B 5/02; G06V 20/40; G06V 40/16; G06V 40/20

(52) U.S. Cl. CPC G09B 5/02; G06V 20/40; G06V 40/176; G06V 40/20

(57) ABSTRACT

Disclosed herein are systems and methods for machine-learning (ML)-based assessment of a presentation by a presenter and engagement of audience members. The method includes obtaining a presentation video stream, a presenter audio stream, and presentation material. The method also includes evaluating the presentation using a prepared presentation evaluation machine learning model (MLM) configured to generate a presentation score based on the presentation video stream, the presenter audio stream, and the presentation material. The method also includes obtaining a plurality of video streams capturing each respective audience member, a plurality of audio streams for each respective audience member, and a plurality of capture streams. The method also includes evaluating an engagement of at least one audience member using a prepared engagement evaluation MLM. The method further includes generating a comprehension score based on the presentation score and the individual engagement score for the at least one audience member.

### FIELD OF TECHNOLOGY

The present disclosure relates to the field of machine learning, and, more specifically, to systems and methods for machine-learning based methods for assessing a presentation by a presenter and engagement of audience members of the presentation, including providing recommendations for both the presenter and audience members.

### BACKGROUND

When presenters present to a large audience of disengaged audience members, several significant problems arise. In a teaching scenario, a lack of engagement reduces learning outcomes, as students are less likely to retain information or develop an understanding of the subject of the lecture. The absence of interaction diminishes opportunities for discussion and feedback, which contribute to a rich learning experience. For presenters, this disengagement can be demotivating, leading to a decline in the quality of presenting (or teaching) over time. Additionally, unengaged audience members prevent presenters from gauging comprehension effectively, making it harder to adjust teaching strategies to meet the audience member's needs. Ultimately, this creates an inefficient use of time and resources, as the goals of the presentation remain unfilled.

The causes of disengagement are multifaceted. Monotone delivery, a lack of interaction, and overly formal or dense presentation slides can make presentation material feel inaccessible or unimportant. External distractions, such as mobile devices or internet browsing, and the anonymity associated with a large audience member size further contribute to disengagement. Additionally, in a learning scenario, students who lack foundational knowledge or preparation may struggle to follow the lecture, leading to frustration and disinterest. Poor use of technology or visual aids can also make lectures feel outdated and less appealing. Addressing these challenges requires a thoughtful approach, incorporating interactive methods, relatable content, and technology to foster an engaging environment.

### SUMMARY

The present disclosure describes a system and method for a machine-learning based method for assessing a presentation and generating real-time feedback and post-presentation recommendations for the presenter as well as assessing an engagement of audience members of the presentation and generating a real-time engagement score and post-presentation recommendations for the audience members. Some of the technical improvements of the present ability is the ability to train and utilize machine learning models (MLMs) to efficiently assess the quality and effectiveness of a presentation (e.g., lecture) with real-time scores and recommendations using machine-based methods without the need for a manual assessment.

In addition, the present disclosure also describes the ability to train and utilize a MLM to assess the engagement of the audience members of the presentation with real-time scores and recommendations using machine-based methods and making it suitable for large-scale assessments. In addition, the present disclosure describes using the prepared MLMs to provide immediate, personalized scores and provide recommendation for both the presenter and audience members. Allowing the present disclosure to quickly identify areas for improvements and help the presenter and audience members to adjust their presenting and listening style accordingly. By analyzing vast amounts of data in real-time, MLM can analyze and evaluate different factors including dozens of indicators measuring engagement for audience members. This leads to more informed feedback on a level of comprehension of the presentation by the audience members.

Other technical benefits of the present disclosure include the ability to utilize the MLMS to process large volumes of data—such as vocal tones, facial expressions, body language, and audience member reactions—with a level of consistency and objectivity that human evaluators often cannot match. This ensures that feedback is more accurate and less influenced by subjective biases. Moreover, MLMs can analyze live data streams, delivering real-time insights that help presenters adjust their delivery on the spot. By understanding individual behavior patterns and learning preferences, these methods can also provide highly personalized recommendations, suggesting interactive elements or additional resources tailored to specific audience members. Once trained, MLMs can efficiently evaluate numerous presentations and large groups, making it possible to provide detailed, actionable feedback at scale. Over time, these MLMs become increasingly accurate, adapting to changes in presentation styles and audience dynamics. By integrating information from multiple channels—audio, video, and text transcripts—machine learning offers a comprehensive understanding of a presentation's impact, revealing complex patterns that simpler methods might overlook. For presenters, this means insights into which topics and delivery styles resonate most; for audience members, it results in customized learning recommendations that enhance engagement and understanding. Ultimately, the technical advantages of machine learning-based approaches lead to more effective presentations, improved audience engagement, and better learning outcomes.

In one exemplary aspect, a method for machine-learning (ML)-based assessment of a presentation by a presenter and engagement of audience members is disclosed. The method includes: obtaining a presentation video stream of a presentation, a presenter audio stream of a presenter, and presentation material; evaluating the presentation using a prepared presentation evaluation machine learning model (MLM) configured to generate a presentation score based on the presentation video stream, the presenter audio stream, and the presentation material; obtaining, for each audience member participating in the presentation, a plurality of video streams capturing each respective audience member, a plurality of audio streams for each respective audience member, and a plurality of capture streams capturing an interaction of each audience member and a respective computing device; evaluating an engagement of at least one audience member using a prepared engagement evaluation MLM configured to generate an individual engagement score for the at least one audience member based on the plurality of video streams, the plurality of audio streams, and the plurality of capture streams; and generating, by a scoring engine, a comprehension score based at least in part on the presentation score and the individual engagement score for the at least one audience member.

In some aspects, the techniques described herein relate to a method further including based on the comprehension score, an output of the prepared presentation evaluation MLM, and an output of the prepared engagement evaluation MLM, generating, by a recommendation engine, a real-time presenter recommendation or a real-time audience member recommendation; and displaying, on a display, at least one of the real-time presenter recommendation, the real-time audience member recommendation, the comprehension score, the presentation score, or the individual engagement score for the at least one audience member.

In some aspects, the techniques described herein relate to a method, wherein the real-time presenter recommendation comprises at least one of: ask a question, introduce a poll or quiz, call on an audience member, acknowledge contribution of an audience member, slow down, speed up, repeat material, summarize material, present a visual aid, or introduce a break, wherein the real-time audience member recommendation comprises at least one of: take notes, ask questions, respond to prompts, use non-verbal feedback, participate in chat, adjust computing environment, or change physical posture.

In some aspects, the techniques described herein relate to a method further including: identifying a subject matter for the presentation and recognizing topics for the presentation using a topic MLM configured to determine main topics of the presentation based on the presentation material; evaluating the presentation of each topic of the presentation using the prepared presentation evaluation MLM configured to generate a respective presentation score for each topic based on the subject matter, recognized topic, presentation video stream, the presenter audio stream, and the presentation material; and evaluating the engagement of at least one audience member for each topic of the presentation using the prepared engagement evaluation MLM configured to generate a respective engagement score of the at least one audience member for each topic based on the subject matter, the recognized topic, the plurality of video streams, the plurality of audio streams, and the plurality of capture streams.

In some aspects, the techniques described herein relate to a method further including: evaluating a group engagement of audience members for the presentation by generating, using the score engine, a group engagement score based on a plurality of engagement scores for each audience member participating in the presentation.

In some aspects, the techniques described herein relate to a method further including: evaluating a group engagement of audience members for each topic of the presentation using the prepared engagement evaluation MLM configured to generate a respective group engagement score of audience members for each topic based on the subject matter, the recognized topic, the plurality of video streams, the plurality of audio streams, and the plurality of capture streams.

In some aspects, the techniques described herein relate to a method further including: preparing the presentation evaluation MLM by: (1) providing, to the presentation evaluation MLM, a presentation training dataset comprising at least one of: (a) presenter video streams of presenters presenting a presentation labeled and annotated with quality scores for clarity, engagement, accuracy, or content delivery to evaluate at least one of body language, gestures, facial expressions, or visual aids of the presenter, (b) corresponding audio streams labeled and annotated for features of at least one of voice quality, pauses, tone, or fluency to analyze speech delivery, clarity, tone, or impact of the presenter, (c) presentation material aligned with the labeled presenter video streams labeled and annotated to assess at least one of content quality, relevance, or alignment between the presentation and the presentation materials, and (d) ground truth labels for the presenter video streams, the corresponding audio streams, or the presentation material to serve as a target output for the presentation evaluation MLM model; and (2) preparing the presentation evaluation MLM using the presentation training dataset

In some aspects, the techniques described herein relate to a method further including: preparing the engagement evaluation MLM by: (1) providing, to the engagement evaluation MLM, an engagement training dataset comprising at least one of: (a) individual video streams of audience members of a presentation labeled and annotated with facial expressions, gaze direction, body posture, or head movement to capture visual engagement cues, (b) corresponding audio streams labeled and annotated with speech activity, tone analysis, interruptions and pauses, or emotion detection to analyze participation through voice contribution and tone of speech, (c) capture streams of the audience members comprising at least one of keyboard input, mouse movements, or screen interactions, wherein the capture streams are labeled and annotated with active engagement, passive behavior, or multitasking to measure interaction of the audience members with a respective computing device, (d) an event list comprises at least one of interaction events, participation events, attention-related events, engagement-related events, time-based events, or behavioral and biometric events annotated with engagement levels, activity frequency, or contribution quality to capture session-specific events that indicate audience member engagement, and (e) ground truth labels for the individual video streams, the corresponding audio streams, the capture streams, or the event list to serve as a target output for the engagement evaluation MLM; and (2) preparing the engagement evaluation MLM using the provided engagement training dataset.

In some aspects, the techniques described herein relate to a method further including: preparing the topic MLM by: (1) providing, to the topic MLM, a topic training dataset comprising at least one of: (a) presentation materials labeled and annotated with subject matter, key topics, or keywords and phrases to extract and analyze a textual and visual content of the presentation to infer the subject matter and individual topics, (b) topic labeled datasets comprising at least domain-specific data labeled and annotated with subject matter tags and topics to train the topic MLM to recognize subject matter and topics, (c) audio and video presentation data comprising at least presentation recordings and corresponding audio streams labeled and annotated with subject matter and topics to identify spoken words, tone, and context for recognizing topics, and (d) ground truth labels for the presentation materials, topic labeled datasets, or audio and video presentation data to serve as a target output for the topic MLM; and (2) preparing the topic MLM using the provided topic training dataset.

In some aspects, the techniques described herein relate to a method further including: generating, by a recommendation engine, and displaying, on a display, a post-presentation presenter recommendation or a post-presentation audience member recommendation based on outputs of the prepared presentation MLM and the prepared engagement evaluation MLM.

In some aspects, the techniques described herein relate to a method, wherein the post-presentation presenter recommendation comprises at least one of: changing content of the presentation, changing speech for the presentation, or changing activities of the presentation.

In some aspects, the techniques described herein relate to a method, wherein the post-presentation audience member recommendation comprises at least one of: assigning additional reading, recommendation to watch video of the presentation, request participation in subsequent presentations, or assign a quiz.

According to one aspect of the disclosure, a system is provided for machine-learning (ML)-based assessment of a presentation and engagement for an audience member, the system including: at least one memory, and at least one hardware processor coupled with the at least one memory and configured, individually or in combination, to: obtain a presentation video stream of a presentation, a presenter audio stream of a presenter, and presentation material; evaluate the presentation using a prepared presentation evaluation machine learning model (MLM) configured to generate a presentation score based on the presentation video stream, the presenter audio stream, and the presentation material; obtain, for each audience member participating in the presentation, a plurality of video streams capturing each respective audience member, a plurality of audio streams for each respective audience member, and a plurality of capture streams capturing an interaction of each audience member and a respective computing device; evaluate an engagement of at least one audience member using a prepared engagement evaluation MLM configured to generate an individual engagement score for the at least one audience member based on the plurality of video streams, the plurality of audio streams, and the plurality of capture streams; and generate, by a scoring engine, a comprehension score based at least in part on the presentation score and the individual engagement score for the at least one audience member.

In one exemplary aspect, a non-transitory computer-readable medium is provided storing a set of instructions thereon for machine-learning (ML)-based assessment of a presentation and engagement for an audience member, the system, including instructions for: obtaining a presentation video stream of a presentation, a presenter audio stream of a presenter, and presentation material; evaluating the presentation using a prepared presentation evaluation machine learning model (MLM) configured to generate a presentation score based on the presentation video stream, the presenter audio stream, and the presentation material; obtaining, for each audience member participating in the presentation, a plurality of video streams capturing each respective audience member, a plurality of audio streams for each respective audience member, and a plurality of capture streams capturing an interaction of each audience member and a respective computing device; evaluating an engagement of at least one audience member using a prepared engagement evaluation MLM configured to generate an individual engagement score for the at least one audience member based on the plurality of video streams, the plurality of audio streams, and the plurality of capture streams; and generating, by a scoring engine, a comprehension score based at least in part on the presentation score and the individual engagement score for the at least one audience member.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for assessing a presentation for a presenter and engagement level of audience members and providing recommendations for the presenter and the audience members according to aspects of the present disclosure.

FIG. 2 is a block diagram illustrating a system for preparing machine learning models to assess a presentation of a presenter and engagement level for audience members according to aspects of the present disclosure.

FIG. 3 is an example flowchart for generating a comprehension score based on a presentation and engagement score according to aspects of the present disclosure.

FIG. 4 is an example of a topic list and presentation, engagement, and comprehension scores for each topic according to aspects of the present disclosure.

FIG. 5 is an example of a user interface for presenting real-time scores and recommendations for presenters and audience members according to aspects of the present disclosure.

FIG. 6 is an example method for a machine-learning (ML)-based assessment of a presentation by a presenter and engagement of audience members according to an aspect of the present disclosure.

FIG. 7 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for a machine-learning (ML) based assessment of a presentation by presenter engagement of audience members and providing a real-time score and recommendations for the presenter and audience members. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In recent years, the application of ML-based methods to assess presentations and audience member engagement has gained significant attention. These approaches leverage advanced algorithms to analyze a wide range of data, including vocal tone, facial expressions, body language, and audience feedback. By analyzing data like speech patterns, body language, facial expressions, and audience member feedback, these methods remove human bias and deliver consistent, data-driven assessments. The ML-based methods also allow real-time feedback, helping presenters adapt on the spot to maintain interest and address disengagement. Furthermore, ML can personalize real-time and/or post-presentation recommendations, offering tailored suggestions for both presenters and audience members based on observed behaviors and engagement levels. This leads to more effective presentations, better audience experiences, and improved learning outcomes.

Using ML-based methods to assess presentations and audience member engagement offers several important benefits. First, these methods bring a level of objectivity and consistency that is difficult to achieve through manual evaluations. They analyze large volumes of data—such as voice tone, facial expressions, and audience reactions—providing unbiased, evidence-driven insights. This enhances the reliability of the feedback and helps presenters refine their techniques more effectively.

Additionally, ML enables real-time assessment. The present disclosure can identify when audience engagement wanes and alert the presenter immediately, allowing for on-the-fly adjustments to maintain interest and improve communication. This timely feedback can lead to more dynamic and responsive presentations, fostering a stronger connection with the audience.

Another significant advantage is personalization. ML systems can identify individual preferences and engagement patterns, allowing for tailored recommendations. For example, a system might suggest more visual aids for visual learners or more interactive elements if it detects higher engagement during Q&A segments. This customization benefits both presenters and audience members, helping to ensure that everyone involved gets the most out of the presentation experience.

Finally, the scalability and efficiency of ML methods allow them to be used repeatedly and on a larger scale without additional manual effort. Over time, as more data is collected, the system improves in accuracy and nuance, continuously providing actionable insights. This leads to better-prepared presenters, more engaged audiences, and ultimately more effective communication and learning outcomes.

Accordingly, the present disclosure assesses a quality and effectiveness of a presentation by a presenter and the focus and engagement level of audience members. One aspect involves analyzing the presenter and presentation material using a prepared presentation MLM configured to generate a presentation score for the presenter. A second aspect involves analyzing the audience members of the presentation using a prepared engagement MLM configured to generate individual engagement scores for each audience member. A third aspect involves generating a comprehension score for the audience members based on the presentation score by the presenter and the engagement scores of the audience members. A fourth aspect involves determining a topic list for the presentation and generating presentation scores and/or engagement scores for each topic from the topic list during the presentation. A fifth aspect involves generating real-time and/or post-presentation recommendations for both the presenter and the audience members. Turning now to the figures, example aspects are depicted with reference to one or more components described herein, where components in dashed lines may be optional.

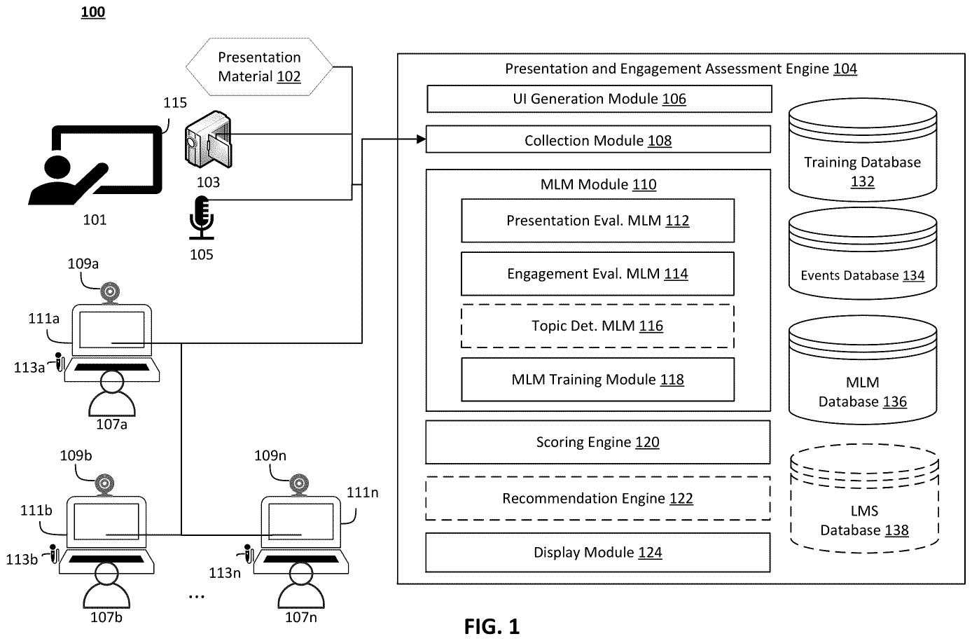

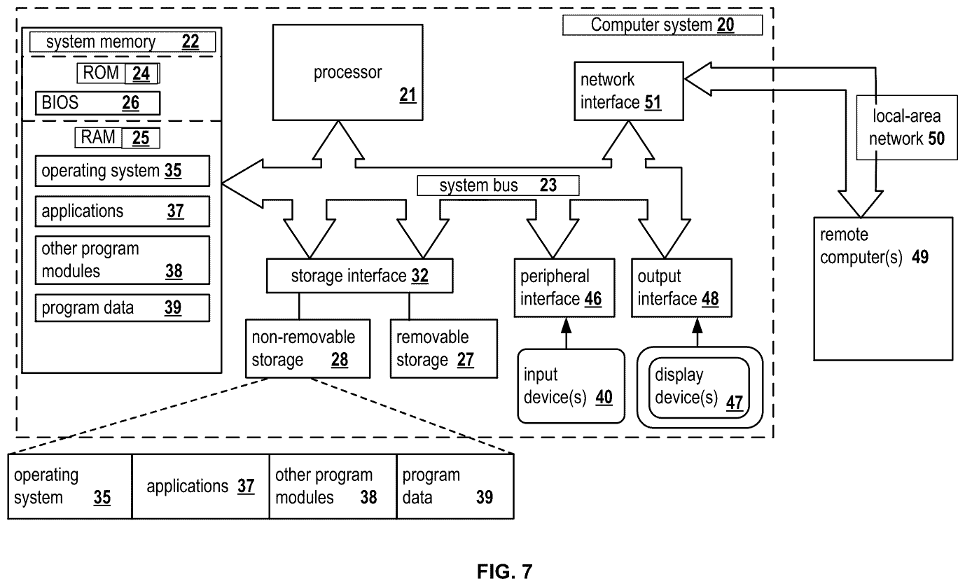

FIG. 1 is a block diagram illustrating a system 100 configured for assessing a presentation by a presenter and engagement of audience members of the presentation, including providing recommendations for both the presenter and audience members. In one aspect, the components of system 100 may be implemented on computer systems, such as that shown in FIG. 7.

The system 100 may be used to assess a presentation by a presenter 101 and engagement by the audience members 107a, 107b, 107n. The presentation and engagement assessment engine 104 is configured to analyze presentation material 102 and a quality and effectiveness of the presentation by the presenter 101 based on a video stream and audio stream of the presenter. In addition, the presentation and engagement assessment engine 104 is also configured to analyze a focus and engagement of audience members based on capturing a video stream, audio stream, and screen capture of each audience member. Furthermore, the presentation and engagement assessment engine 104 is configured to generate scores indicating the quality and effectiveness of the presenter's presentation style and presentation material, the engagement score and focus level of the audience members, and an overall comprehension level of the material from the presentation by the audience members. This provides a way to implement real-time feedback and personalized recommendations for the presenter and the audience members. In this way, the presentation and engagement assessment engine 104 can quickly analyze data from dozens of cameras, microphones, and screen captures such as vocal tones, facial expressions, body language, and audience member reactions and generate real-time feedback and personalized recommendations for the presenter and audience members, offering a holistic and immediate insights into their presentation and presentation comprehension. Additional input for assessing a presentation can include mobile devices (such as cell phones and tablets), wearable devices, and other technologies that provide data reflecting the behavior of the presenter. This may also involve projectors, whiteboards, and other devices used in delivering a lecture, particularly when evaluating real-room activity. For assessing audience engagement, inputs can include mobile devices, wearable devices, and other technologies that capture data on audience behavior.

The system 100 includes at least presentation material 102, a presenter 101, presenter 101 inputs including at least a camera 103 capturing the presenter 101, a microphone 105, and a computing device 115, at least one audience member 107a of the presentation including at least a corresponding camera 109a, microphone 113a, and a computing device 111a for each audience member 107a, and a presentation and engagement assessment engine 104. The presentation and engagement assessment engine 104 may be configured to analyze and generate scores and/or recommendations for both the presenter 101 and the audience members 107a, 107b, 107n using their corresponding cameras 103, 109a, 109b, 109n, microphones 105, 113a, 113b, 113n, and computing devices 115, 111a, 111b, 111n. The computing device 115 may execute a plurality of modules in the presentation and engagement assessment engine 104 that together make up the collection, analysis, scoring, and recommendation system. In some aspects, the presentation and engagement assessment engine 104 may correspond to the computing device 115 or cloud network (not shown) that is configured to execute a plurality of modules that together make up the presentation and engagement assessment engine 104 for evaluating the presentation for the presenter 101 and engagement of the audience members 107a, 107b, 107n. It should be noted that only three audience members 107a, 107b, 107n are depicted in FIG. 1, the present disclosure is not limited to only three audience members and may be applied to any number of audience members.

In some aspects, the presentation and engagement assessment engine 104 may include a user interface (UI) generation module 106, a collection module 108, a MLM module 110 including at least a presentation evaluation MLM 112, an engagement evaluation MLM 114, an optional topic determination MLM 116, and a MLM training module 118, a scoring engine 120, an optional recommendation engine 122, a display module 124, a training database 132, an events database 134, a MLM database 136, and an optional LMS database 138.

The computing device 115 may execute a UI generation module 106 to implement a UI for display on the computing devices 115, 111a, 111b, 111n that is configured to receive input from the respective computing devices and display real-time scoring and recommendations. In particular, the computing device 115 for the presenter 101 may display real-time scoring of the presentation score along with real-time scoring of the engagement score for the audience members, and comprehension score for the audience members. Accordingly, the computing devices 111a, 111b, 111n for each audience member will only display real-time scoring of their own respective engagement score and recommendations for increasing engagement.

In some aspects, the UI generation module 106 generates a single UI for a presenter 101 and a single layout for the audience members 107a, 107b, 107n and layout and components of the UI elements (e.g., menus, buttons, forms, grids, etc.) based on predefined rules, data models, or templates. In some aspects, the UI generation module 106 may also be configured to automatically adjust the UI elements based on the content or data that it needs to display such as adapting a form to input fields or displaying a list of items. In some aspects, the UI generation module 106 may also be configured to adapt the UI to different screen sizes and resolutions by making sure that the UI works well across various devices.

The computing device 115 may execute a collection module 108 that collects and obtains lecture material 102, data streams from the cameras 103, 109a, 109b, 109n, microphones 105, 113a, 113b, 113n, and screen captures of the computing devices 111a, 111b, 111n to evaluate the presentation and engagement for generating both real-time presentation and engagement feedback and recommendations. In some aspects, portions of the lecture material 102 may be stored on a training database 132. In some aspects, data from the cameras 103, 109a, 109b, 109n, microphones 105, 113a, 113b, 113n, and screen captures of the computing devices 111a, 111b, 111n may be stored in the events database 134. In some aspects, the prepared presentation evaluation MLM, the engagement evaluation MLM, and the topic determination MLM may be stored on a MLM database 136. In some aspects, the training database 132, the events database 134, the MLM database 136, and the optional LMS database 138 may be stored on a local device or a cloud network.

In some aspects, data for each audience member 107a, 107b, 107n may be obtained from Learning Management System (LMS) data by the collection module 108. The LMS is a software platform that helps educators manage, deliver, and track educational content and training programs. It acts as a central hub for creating, distributing, and organizing learning materials, assignments, assessments, and communications for both in-person and online learning environments. With an LMS, instructors can create courses, upload content (like readings, videos, or quizzes), and manage assignments, grades, and attendance all in one place. Learners can access their course materials, submit assignments, take quizzes, engage in discussions, and receive feedback directly within the system. LMS platforms are widely used by educational institutions, corporations, and organizations for both formal education and professional training, as they provide a scalable way to deliver personalized learning experiences and track learner progress effectively.

The LMS data may be categorized broadly based on the various functions and interactions that take place within the LMS. The LMS data may include course data that includes information about courses such as course titles, descriptions, syllabus details, instructional content (documents, videos, quizzes), learning modules, and activities. It also includes course duration, structure, and related resources used by learners and instructors. LMS data may include learning progress data that captures learners' progress through their courses. It includes information about course completion rates, progress tracking, assignments submitted, quiz scores, badges earned, and time spent on different sections or lessons. Learning progress data helps instructors assess how well learners are following along and identify areas where additional support might be needed. LMS data may include assessment data comprises all the information related to evaluations, such as quiz and test scores, feedback on assignments, participation in assessments, and grades. It also includes performance trends over time and proficiency scores in specific topics. LMS data may also include engagement data measures how actively learners participate within the LMS environment. This can include metrics such as login frequency, participation in discussion forums, completion of activities, and engagement with course content (e.g., clicks on videos, frequency of accessing reading materials). LMS data may also include behavioral data records learners' interactions with the LMS, such as login timestamps, clicks, navigation behavior, time spent on different resources, and sequences of actions taken. This data helps to understand usage patterns and identify potential roadblocks or opportunities for improving the learning experience.

LMS data may also include feedback data refers to any comments, surveys, or ratings submitted by learners regarding courses or the overall learning experience. It includes instructor feedback provided to learners on assignments or exams as well. LMS data may also include completion data that involves data on course outcomes, such as completed modules, final grades, earned certifications, and dropout rates. Completion data provides insights into learner success and course effectiveness. LMS data may also include attendance data that indicates who attended, how often learners join live lectures or webinars, and any participation rates in live components of the learning. LMS data may also include learning paths and recommendations that reflect personalized paths assigned to different learners, which might include prerequisites completed, courses recommended, suggested resources, and individualized learning plans.

In some aspects, presentation material 102 may be obtained by the collection module 108. The presentation material 102 may include at least presentation slides, lecture notes, speaking notes, readings and references, multimedia content, case studies and examples, exercise and practice questions, diagrams and chats, discussion prompts, or supplementary resources. The presentation material 102 serves as a guide to the core concepts and topics covered in the presentation. Presentation material 102 provides a structured outline that covers both theoretical frameworks with practical examples to enhance understanding. In some aspects, lecture material may encourage active participation through discussion prompts and exercises to lay a solid foundation for further exploration and mastery of the subject.

The computing device 115 may execute a MLM module 110 including at least a presentation evaluation MLM 112, an engagement evaluation MLM 114, an optional topic determination MLM 116, and a MLM training module 118.

In some aspects, the MLMs in the MLM modules 110 may correspond to a large language model (LLM). It should be noted that LLMs are described in this present disclosure for illustrative purposes only and that any suitable MLM may be utilized to perform the particular specific tasks of the presentation evaluation MLM 112, the engagement evaluation MLM 114, and the optional topic determination MLM 116.

A LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (e.g., training, retraining, distillation, fine-tuning, etc.) to teach each LLM model to perform their respective specific tasks. As a nonlimiting example, the LLM models may incorporate one of the machine learning models listed below.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are generative pre-trained transformer (GPT) and Bidirectional Encoder Representations from Transformers (BERT).

A classification model is a type of machine learning model that is designed to predict the category or class to which a given data point belongs to. The classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machine (SVM) configured to perform classification by finding the best boundary between classes, and neural networks.

In some examples, a prepared presentation evaluation MLM 227a may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by the presentation evaluation MLM may be one of the following: transformer neural network, convolution neural network (CNN), recurrent neural network (RNN), long short-term memory (LSTM) network, gated recurrent unit (GRU) network, autoencoder, generative adversarial network (GAN).

An autoencoder is a type of neural network used for unsupervised learning and dimensionality reduction and consists of an encoder that compresses input data into a lower-dimensional representation (encoding) and a decoder that reconstructs the original input from the encoding.

For analysis tasks such as evaluating the presentation or generating a score and/or feedback, an untrained presentation evaluation MLM 112 will first analyze data from a training set to “learn” what is considered an effective presentation material and/or style and generate feedback indicating a quality and effectiveness of the particular presentation. As an example, the training dataset may include at least: (a) presenter video streams of presenters presenting a presentation labeled and annotated with quality scores for clarity, engagement, accuracy, or content delivery to evaluate at least one of body language, gestures, facial expressions, or visual aids of the presenter, (b) corresponding audio streams labeled and annotated for features of at least one of voice quality, pauses, tone, or fluency to analyze speech delivery, clarity, tone, or impact of the presenter, (c) presentation material aligned with the labeled presenter video streams labeled and annotated to assess at least one of content quality, relevance, or alignment between the presentation and the presentation materials, and (d) ground truth labels for the presenter video streams, the corresponding audio streams, or the presentation material to serve as a target output for the presentation evaluation MLM model.

During training of the presentation evaluation MLM 112, the results from the untrained MLM are then compared with known data set results using the corresponding labels identifying different types of presentation styles and their effectiveness. It should be noted that the input to the trained MLM in the presentation evaluation MLM 112 will be data from the training dataset.

For every input training sample from the training dataset, the trained MLM in the presentation evaluation MLM 112 will produce a prediction consisting of values representing a probability that a particular presentation style is ineffective or effective in the form of a score based on the video stream of the presenter from the camera 103, the presentation material 102, and the audio stream of the presenter 101. The output with the highest probability determines the predicted score. A class label for each answer may be used to compute a loss (e.g., loss function).

The trained MLM in the presentation evaluation MLM 112 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the MLM is trained (e.g., inference), the trained presentation evaluation MLM from the presentation evaluation MLM 112 may evaluate the presentation by comparing them with different presentations ranging from ineffective presentation to effective presentations and generate real-time feedback that indicates a level of effectiveness of the presentation with a score.

During inference, the trained presentation evaluation MLM from the presentation evaluation MLM 112 does not re-evaluate or adjust the layers of the neural network based on the results. Instead, the inference applies knowledge from the trained neural network and uses it to infer a result. Accordingly, when a new unknown dataset (e.g., new presentation) is input through the prepared MLM in the trained presentation evaluation MLM from the presentation evaluation MLM 112, the trained MLM outputs a score evaluating the presentation based on predictive accuracy of the MLM.

Similarly, during preparation (e.g., training) of the engagement evaluation MLM in the engagement evaluation MLM 114, the engagement training dataset will include training including at least one of: (a) individual video streams of audience members of a presentation labeled and annotated with facial expressions, gaze direction, body posture, or head movement to capture visual engagement cues, (b) corresponding audio streams labeled and annotated with speech activity, tone analysis, interruptions and pauses, or emotion detection to analyze participation through voice contribution and tone of speech, (c) capture streams of the audience members comprising at least one of keyboard input, mouse movements, or screen interactions, wherein the capture streams are labeled and annotated with active engagement, passive behavior, or multitasking to measure interaction of the audience members with a respective computing device, (d) an event list comprises at least one of interaction events, participation events, attention-related events, engagement-related events, time-based events, or behavioral and biometric events annotated with engagement levels, activity frequency, or contribution quality to capture session-specific events that indicate audience member engagement, and (e) ground truth labels for the individual video streams, the corresponding audio streams, the capture streams, or the event list to serve as a target output for the engagement MLM. In some aspects, analyzing the engagement of the audience members using LMS data from the optional LMS database 138. It should be noted that the input to of the engagement evaluation MLM in the engagement evaluation MLM 114 will be data from the training dataset.

In some aspects, the individual video streams, corresponding audio streams, and/or capture streams may be obtained and stored on an events database 134 such that the data from each stream is indicative of engagement. As a non-limiting example, the events that may be detected or identified may include at least one of: facial expressions (e.g., smiling, nodding, or raising eyebrows as a sign of agreement, interest, or curiosity for engagement), eye contact (e.g., maintaining eye contact with the presenter or the visual aids or avoiding signs of distraction, such as frequently looking at phones, watches, or around the room), posture (e.g., leaning forward as a sign of interest and attentiveness or sitting upright, as opposed to slouching or reclining, which may indicate disengagement.), gestures and movements (e.g., nodding in agreement or making thoughtful gestures or limited fidgeting, restlessness, or other signs of distraction), participation (e.g., actively asking questions, responding to prompts, or interacting with the presenter or engaging in discussions or showing enthusiasm during group activities), verbal cues (e.g., providing thoughtful and relevant answers to questions posed by the presenter, making comments or contributions that reflect understanding and attention, or expressive and engaged tones when speaking, rather than monotone or hesitant replies), behavioral interaction with tools or aids (e.g., engagement with provided tools, such as polls, quizzes, or note-taking applications), or social interaction (e.g., collaborative engagement with other audience members during group activities or discussions).

For every input training sample from the training dataset, the trained MLM from the engagement evaluation MLM 114 will produce a prediction consisting of values representing a probability corresponding to an evaluation of a level of engagement (or focus) of the presentation by each audience member based on the video streams from the cameras 109a, 109b, 109n, the audio stream from the microphones 113a, 113b, and 113n, and the capture screens of the computing devices 111a, 111b, 111n. The output with the highest probability determines the generated score indicating a level of engagement and focus of each audience member.

Similar to the trained MLM in the presentation evaluation MLM 112, the trained MLM from the engagement evaluation MLM 114 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal.

During inference, the trained MLM from the engagement evaluation MLM 114 does not re-evaluate or adjust the layers of the MLM based on the results. Instead, the inference applies knowledge from the trained MLM and uses it to generate an evaluation (e.g., engagement score) and engagement feedback. Accordingly, when a new unknown dataset (e.g., new presentation) is input through the trained MLM in the engagement evaluation MLM 114, the trained MLM outputs a prediction of an engagement level based on the video streams from the cameras 109a, 109b, 109n, the audio stream from the microphones 113a, 113b, and 113n, and the capture screens of the computing devices 111a, 111b, 111n in the form of a score.

Optionally, during training of the MLM in the optional topic determination MLM 116, the topic training dataset will include (a) presentation materials labeled and annotated with subject matter, key topics, or keywords and phrases to extract and analyze a textual and visual content of the presentation to infer the subject matter and individual topics, (b) topic labeled datasets comprising at least domain-specific data labeled and annotated with subject matter tags and topics to train the topic MLM to recognize subject matter and topics, (c) audio and video presentation data comprising at least presentation recordings and corresponding audio streams labeled and annotated with subject matter and topics to identify spoken words, tone, and context for recognizing topics, and (d) ground truth labels for the presentation materials, topic labeled datasets, or audio and video presentation data to serve as a target output for the topic MLM.

In some aspects, an optimizer such as Adam or SGD may be used to train the models in the presentation evaluation MLM 112, the engagement evaluation MLM 114, and the optional topic determination MLM 116. In some aspects, the data may be split into training, validation, and test sets. In these aspects, the MLMs from the presentation evaluation MLM 112, the engagement evaluation MLM 114, and the optional topic determination MLM 116 are trained on the training dataset and then validated by the validation sets to tune hyperparameters.

The computing device 115 may execute a scoring engine 120 configured to generate a comprehension score based at least in part on the presentation score from the prepared presentation evaluation MLM and the engagement scores from the prepared engagement evaluation MLM. The comprehension score is a measure of how well each audience member appears to understand the material discussed in the presentation. Specifically, the comprehension score is derived by integrating the presentation score, which evaluates the quality and clarity of the presenter's presentation based on the output of a presentation evaluation MLM, with engagement scores of each audience member based on the output of the engagement evaluation MLM. As mentioned above, the presentation score reflects how effectively the content is structured and delivered, while the engagement scores measure the audience's responsiveness and interaction levels during the presentation. The scoring engine's ability to combine these metrics provides a nuanced understanding of both the presenter and their presentation's efficacy and its impact on the audience. This system is significant as it enables data-driven insights for improving communication strategies, ensuring presentations are not only well-crafted but also engaging and impactful for their intended audiences.

In some aspects, the scoring engine 120 functions by aggregating and analyzing outputs from the two specialized machine learning models: the presentation evaluation MLM 112 and the engagement evaluation MLM 114. In some aspects, the scoring engine 120 may apply predefined or dynamically learned weights to balance the relative importance of these scores, ensuring the final comprehension score accurately reflects the interplay between content and presentation quality and audience engagement and/or participation. Advanced algorithms may then integrate the weighted scores to generate a unified comprehension score that quantifies the overall effectiveness of the presentation in conveying information and engaging the audience. This comprehensive evaluation enables actionable feedback, highlighting areas for improvement and identifying strategies that enhance presentation impact.

The computing device 115 may execute an optional recommendation engine 122. Using the data from the video streams, audio streams, screen captures, presentation score, engagement score, and/or comprehension score, a real-time presenter recommendation and/or a real-time audience member recommendation is generated. The real-time presenter recommendation are recommendations on how to more effectively present and engage the audience members. In some aspects, the real-time presenter recommendations may be generated post-presentation. As a non-limiting example, the real-time presenter recommendations may include at least one of introducing a poll or quiz, calling on an audience member, acknowledge contribution of an audience member, slow down, speed up, repeat material, summarize material, present a visual aid, or introduce a break.

In addition, the real-time and/or post-presentation recommendations for audience members are personalized recommendations for each audience member on how to be more engaged with the presenter and presentation. As a non-limiting example, the real-time presenter recommendations may include at least one of taking notes, asking questions, responding to prompts, using non-verbal feedback, participating in a chat, adjusting a computing environment, or changing a physical posture.

The computing device 115 may execute a display module 124. The display module 124 may be configured to generate and display the scores and feedback for the presenter 101 and the audience members 107a, 107b, 107n and/or at least a list of topics for the presentation on their respective computing devices 115, 111a, 111b, 111n. Generally, the display module 124 is responsible for managing and rendering the visual components of the user interface by handling the presentation of information to the user, ensuring that data and controls are displayed correctly and consistently across the UI.

In some aspects, the display module 124 is configured to render or draw all the elements of the UI, such as windows, buttons, text fields, menus, icons, images, and other components. In some aspects, the display module 124 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 124 may be considered the “view” part of a model-view-controller (MVC) or similar design pattern. It serves as the layer that presents data to the user and receives input to and from the computing devices 115, 111a, 111b, 111n.

It should be noted that although the analysis and evaluation of the presentation material, the presenter, and the engagement of the audience members described in the present disclosure are heavily simplified. One skilled in the art will appreciate that the MLMs utilized may have significantly large datasets with highly specific details. For example, features indicating personal engagement of the audience members may include at least one of time in front of camera, speaking time, sharing time, reactions, raising their hand, messaging in the chat, focus on the presentation, switching between browser tabs, etc. As another example, features indicating the quality and effectiveness of a presenter may include at least one of clarity of speech (e.g., evaluation of pronunciation, enunciation, pace, and volume), structure and organization (e.g., assessment of how well the presentation is organized, including logical flow, clear transitions between topics, and adherence to a coherent narrative), engagement and interaction (measurement of the presenter's ability to connect with the audience through eye contact, gestures, interactive questions, and responses to audience cues), non-verbal communication (e.g., analysis of body language, posture, facial expressions, and hand gestures to determine whether they reinforce the message or create distractions), use of visual aid (e.g., evaluation of the effectiveness of slides, charts, or other visual tools in complementing the spoken content and aiding comprehension), adaptability (e.g., evaluation of the presenter's ability to adjust based on audience feedback, such as modifying the pace, tone, or content emphasis to maintain interest and understanding), energy and enthusiasm (e.g., observation of the presenter's enthusiasm and passion for the topic, which can influence audience interest and engagement), time management (e.g., assessment of whether the presenter adheres to the allotted time, balancing depth of information with pacing to cover key points effectively), and audience engagement metrics (e.g., use of audience data, such as their responses, body language, or interaction levels, to gauge how effectively the presenter maintains attention and participation). This type of analysis would be beyond the capabilities of the human mind because the amount of data to be identified, considered, and processed when evaluating both a presenter and each individual audience members. It should also be noted that although the present disclosure is described in terms of presentations are for illustrative purposes only, the methods and systems described in the present disclosure can be applied to any type of presentation such as a lecture, sales pitch, business meeting, speeches, storytelling, business strategy meetings, funding proposals, team meetings, workshops, stand-up comedy acts, event hosting and the like.

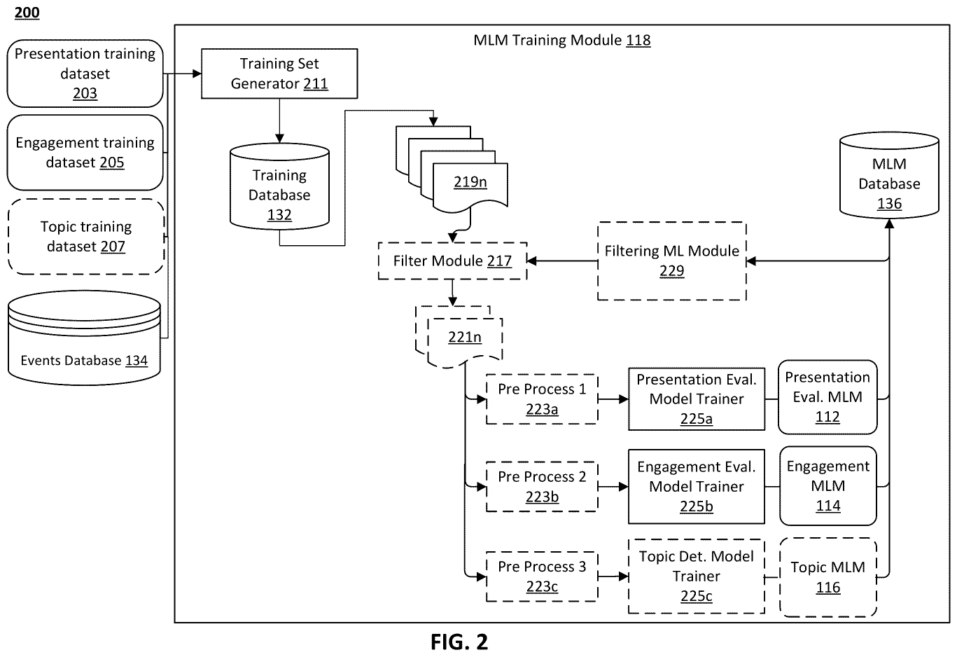

FIG. 2 is a block diagram illustrating a system for preparing machine learning models to assess a presentation of a presenter and engagement level for audience members according to aspects of the present disclosure. As shown in example 200, the MLM training module 118 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled training data sets, the specialized machine learning models may perform particular tasks such as evaluating a presentation by generating a presentation score, evaluating an engagement of the audience members by generating an engagement score, and/or identifying a subject matter for the presentation.

Supervised learning is effective for tasks such as classification (assigning inputs to predefined categories) and regression (predicting continuous values) since it relies on the availability of labeled data for both training and evaluation phases. In supervised learning, the MLM training module 118 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 118 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 118 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 118 includes at least a training database 132 configured to store the raw training data 219n and corresponding labels, a MLM database 136 to store the trained models (e.g., the prepared presentation evaluation MLM 112, the prepared engagement evaluation MLM 114, and/or an optional prepared topic determination MLM 116). In some aspects, the MLM training module 118 may include an optional filtering machine learning model 229 and an optional filter module 217 configured to filter data from the training database 132 for training by removing poorly generated training data.

Training data from the presentation training dataset 203, engagement training dataset 205, optional topic training dataset 207, and events from the events database 134 is received into the MLM training module 118 via the training set generator 211. Details about the data included in each training dataset is described in more detail above with FIG. 1.

An optional filter module 229 is configured to filter out bad training images and/or data to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a, preprocess 2 223b, and preprocess 3 223c are automated processes that modify the raw data received from 219n (or cleaned training dataset 221n) and prepare the raw data as input to the respective model trainers (e.g., presentation evaluation model trainer 225a, engagement evaluation model trainer 225b, or optional topic determination model trainer 225c). These may be described in the MLM training module 118 as snippets of code that prepares the datasets. In some examples, the preprocessing module (e.g., preprocess 1 223a, preprocess 2 223b, and preprocess 3 223c) for a particular trainer may be an automated script or code that will be setup the first time any model is trained.

The presentation evaluation model trainer 225a, engagement evaluation model trainer 225b, or optional topic determination model trainer 225c are the scripts or code that train the respective models. The presentation evaluation model trainer 225a, engagement evaluation model trainer 225b, or optional topic determination model trainer 225c may be a script or code that holds the instructions on how a model should be trained (e.g., optimization method, model architecture, dataset division, etc.) and runs the training. The presentation evaluation model trainer 225a, engagement evaluation model trainer 225b, or optional topic determination model trainer 225c each take as input the raw or filtered processed training data and train the presentation evaluation model trainer 225a, engagement evaluation model trainer 225b, or optional topic determination model trainer 225c to achieve their specific objectives, respectively.

In summary, the raw dataset 219 or cleaned dataset 221n may optionally go through different preprocessing steps 223a, 223b, 223c and then a corresponding presentation evaluation model trainer 225a, engagement evaluation model trainer 225b, or optional topic determination model trainer 225c to generate a prepared presentation evaluation MLM 112, a prepared engagement evaluation MLM 114, or an optional prepared topic determination MLM 116. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training images from the training database 132. Accordingly, to create a clean and filtered training dataset, the optional filter module 217 is configured to filter out unwanted data points from the raw training dataset 219n by developing smaller, less accurate systems based on patterns and metadata information.

During the training process, the presentation evaluation model trainer 225a, the engagement evaluation model trainer 225b, or the optional topic determination model trainer 225c are presented with input data and labels of actual values, and the optimization objective, which aims to minimize the difference between the actual value and the predicted value, is calculated. The optimization algorithm updates the parameters of the presentation evaluation model trainer 225a, the engagement evaluation model trainer 225b, or the optional topic determination model trainer 225c to reduce the value of the objective. This process is repeated for several iterations until the parameters do not change anymore. This process is repeated for various combinations of hyperparameters, and the model with the smallest label prediction error is selected as the final model.

When a new model (e.g., the prepared evaluation MLM 112, the prepared engagement evaluation MLM 114, and the optional prepared topic MLM 116) is created, and a new process for filtering and automated labeling is established, it is added to the MLM database 136 in the MLM training module 118. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a mathematical model. This approach may capture changes in the data over time.

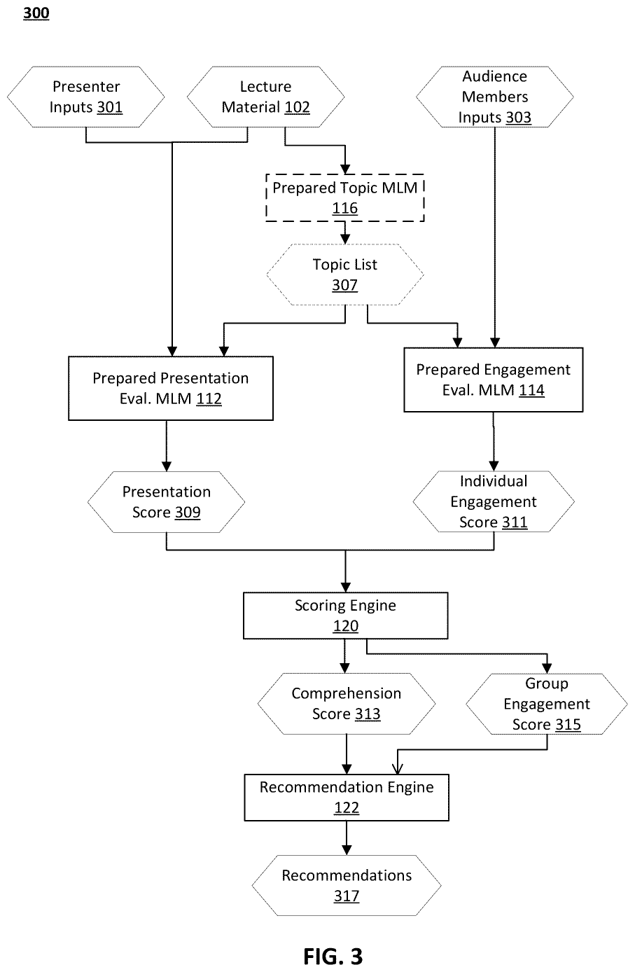

FIG. 3 is an example flowchart for generating a comprehension score, an engagement score, and recommendations based on the presentation and engagement score according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 600 is performed by a processor executing code stored in a non-transitory computer-readable medium (e.g., a memory). The method 300 describes a method for generating a comprehension score, an engagement score, and recommendations based on the presentation and engagement score.

The method 300 begins by inputting presenter inputs 301 (e.g., video stream data from the camera 103 and audio stream data from the microphone 105) and lecture material 102 into the prepared presentation evaluation MLM 112 to output a presentation score 309. The presenter inputs 301 reflect the presenter's visual and verbal communication, such as gestures, facial expressions, speech clarity, and tone. Additionally, the prepared presentation evaluation MLM 112 integrates lecture material 102, such as slides or notes, to ensure alignment with the presenter's delivery. These presenter inputs 301 are then processed by the prepared presentation evaluation MLM 227a, a MLM prepared to analyze and assess presentations using techniques such as natural language processing, audio analysis, and computer vision. The presentation and engagement assessment engine 104 evaluates various aspects of the presentation, including the presenter's body language, vocal delivery, and the coherence of their content, ultimately outputting a presentation score 309.

The presentation score 309 offers an objective and standardized way to evaluate presentations, reducing the subjectivity associated with human evaluations. Presenters can use this presentation score 309 as feedback to identify strengths and areas for improvement, such as enhancing clarity, refining body language, or ensuring better alignment between speech and visual aids. The automated nature of the presentation and engagement assessment engine 104 saves time and resources, particularly in scenarios requiring the evaluation of multiple presentations. It also supports learning and development by providing detailed, data-driven insights to improve communication skills. Moreover, by relying on consistent algorithms, the presentation and engagement assessment engine 104 minimizes biases that can occur in human assessments. This scalable and insightful evaluation method has applications across diverse domains, fostering improvement and enabling objective assessments in educational and professional settings.

The method 300 also inputs audience member inputs (e.g., video stream data from the cameras 109a, 109b, 109n, audio stream data from the microphones 113a, 113b, 113n, and screen captures from the computing devices 111a, 111b, 111n) into the prepared engagement evaluation MLM 114 to output an individual engagement score 311 for each audience member. Specifically, the presentation and engagement assessment engine 104 gathers data from audience members (e.g., audience members 107a, 107b, 107n from FIG. 1), including video streams from cameras 109a, 109b, 09n, audio streams from microphones 113a, 113b, 113n, and screen captures from their computing devices 111a, 111b, 111n. These audience member inputs 303 provide detailed information about audience behavior, such as facial expressions, body language, verbal reactions, and interactions with their devices during the presentation. The data is processed by a prepared engagement evaluation MLM 112, a MLM prepared to assess engagement levels using techniques like computer vision, audio analysis, and activity monitoring. The prepared engagement evaluation MLM 112 analyzes each audience member's responses and behaviors to produce an individual engagement score, reflecting their level of attention, interest, or participation during the presentation.

The individual engagement score 315 provide real-time, objective, and granular insights into each audience member's engagement of the presentation. For presenters, understanding the individual engagement scores 315 enables the presenters to adjust their delivery, content, or pacing to better capture and maintain audience focus and interest. As an example, in educational settings, individual engagement scores 315 can help instructors identify learners who may require additional support or tailored teaching methods. As another example, in corporate or sales pitches, the individual engagement scores 315 supports the optimization of presentations, pitches, or performances to maximize impact or focus on particular individuals. The presentation and engagement assessment engine 104's reliance on automated and consistent algorithms minimizes the subjectivity and biases of manual observation while offering scalable insights for large or remote audiences.

The presentation score 309 and the individual engagement score 311 are then input into a scoring engine 120 to output a comprehension score 313 for each audience member. The comprehension score 313 reflects how well the audience members understood or absorbed the content of the presentation. In this way, the individual comprehension score 313 provides detailed, personalized insights into how well an individual audience member understood the content of the presentation. As an example, in an educational setting, the comprehension score 313 can help identify which learners are struggling to grasp the material, enabling targeted interventions or adjustments to teaching methods. As another example, in a corporate setting, the comprehension score 313 can assess the effectiveness of training programs and ensure that employees understand critical information. As yet another example, in a sales pitch, the comprehension score 313 can help the presenter zero in or “close” individuals with a high comprehension score 313 or help the presenter re-explain or adjust their presentation methods if an individual has a low comprehension score 313. The integration of presenter performance and audience engagement ensures that comprehension scores 313 are not solely based on the presenter's delivery or the audience's engagement in isolation, but on a nuanced interaction of both factors. This holistic assessment fosters better communication, supports adaptive strategies for improving understanding, and enhances the overall effectiveness of presentations in educational, professional, and public speaking contexts.

In some aspects, the scoring engine 120 will generate a group engagement score 315 that summarizes an overall engagement score for the group of audience members. Specifically, the scoring engine 120 generates a group engagement score 315 by consolidating the individual engagement scores 311 of all audience members into a unified metric that reflects the overall level of engagement across the entire group. Each audience member's engagement score 311, which is derived from behavioral data such as attentiveness, participation, and interactions during the presentation, is fed into the scoring engine 120. Using statistical aggregation or machine learning algorithms, the scoring engine 120 computes an overall engagement score that represents either the average, median, or cumulative engagement of the group. This process provides a single, high-level measurement of how well the audience collectively responded to the presentation.

The significance of the group engagement score 315 lies in its ability to offer a holistic view of audience interaction and responsiveness. For presenters, it serves as a valuable tool for assessing the success of their presentation in capturing and maintaining the audience's interest. In educational settings, the group engagement score 315 can help instructors gauge the effectiveness of their teaching methods and identify whether the class, as a whole, is engaged with the material. In corporate environments, the group engagement score 315 provides actionable feedback for improving team training sessions, meetings, or large-scale presentations. Furthermore, for event organizers or remote sessions with large audiences, the group engagement score 315 enables quick and efficient evaluation of overall audience satisfaction and participation. This group engagement score 315 aids in identifying broader trends, facilitating data-driven improvements to communication strategies, and ensuring more impactful presentations across various contexts.

In some aspects, the method 300 may include generating a topic list containing important topics for a subject matter of the presentation by inputting the lecture material 102 into an optional prepared topic determination MLM 116. This is accomplished by inputting the lecture material 102 into the optional prepared topic determination MLM 116, which uses natural language processing (NLP) and other techniques to extract and organize key topics from the content of the lecture material 102. Once the topic list 307 is generated, it is used to guide the prepared presentation evaluation MLM 112 and the prepared engagement evaluation MLM 114 to analyze the presentation and audience engagement on a topic-by-topic basis. This enables the presentation and engagement assessment engine 104 to generate presentation scores 309 and individual engagement scores 311 for each topic in the topic list 307, providing granular feedback on how well each specific area was presented by the presenter and received by the audience members.

The method 300 then inputs the comprehension score 313 and, in some cases, the group engagement score 315 into an optional recommendation engine 122 to generate a real-time presenter recommendation and a real-time engagement recommendation for each audience member.

Specifically, the comprehension score 313 and, optionally, the group engagement score 315 are processed by the optional recommendation engine 122, which uses algorithms or machine learning models to generate two types of real-time recommendations 317. The first is a real-time presenter recommendation, offering the presenter strategies to improve delivery, such as adjusting pacing, emphasizing specific topics, or adopting a more engaging tone. The second is a real-time engagement recommendation, which provides personalized advice for improving individual audience members' engagement, such as encouraging participation, offering additional clarifications, or introducing interactive elements.

By delivering real-time recommendations, the presentation and engagement assessment engine 104 allows presenters to dynamically adjust their approach to maintain audience interest and ensure understanding. It also supports personalized learning by tailoring strategies to the needs of individual audience members, which is particularly beneficial in educational and training settings. Additionally, the objective, data-driven nature of the real-time recommendations 317 ensures precision and reduces reliance on intuition or guesswork. This approach improves the overall effectiveness of presentations, enhances audience experiences, and fosters active participation, making it highly versatile for applications in education, corporate training, and live events.

In addition, the method 300 may also generate post-presentation recommendations for the presenter and the audience members. Post-lecture recommendations provide valuable insights for both presenters and audience members, fostering continuous improvement and enhanced learning outcomes. For presenters, these recommendations offer feedback on delivery, content organization, and audience engagement, helping them refine their techniques and address areas needing improvement. For audience members, tailored suggestions support individual learning by addressing comprehension gaps and providing resources for deeper engagement with the material. By creating a feedback loop, post-lecture recommendations ensure future presentations are more effective and impactful while promoting better understanding and participation from the audience.

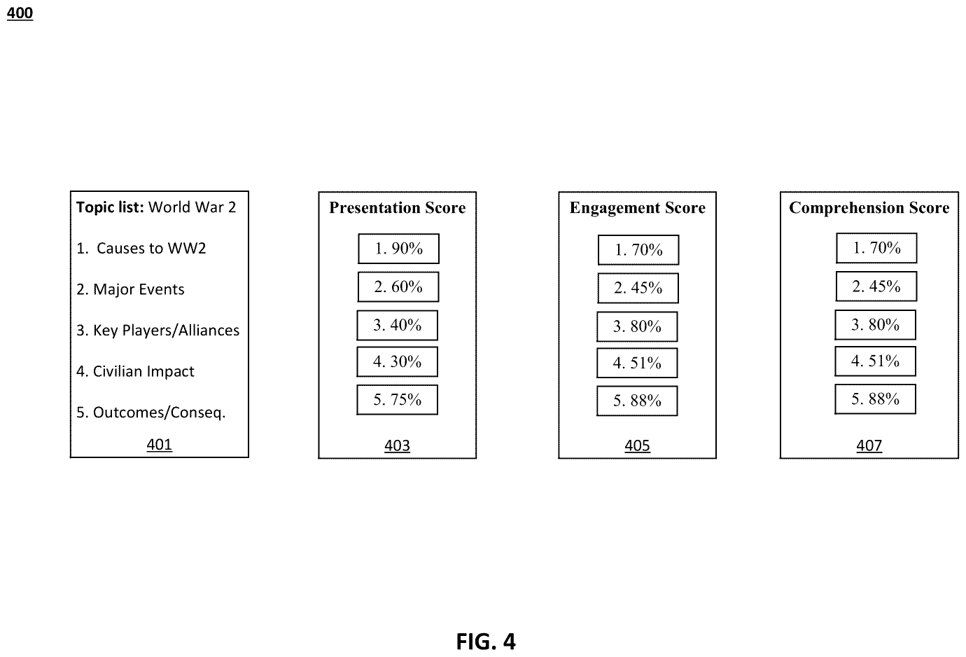

FIG. 4 is an example of a topic list and presentation, engagement, and comprehension scores for each topic according to aspects of the present disclosure. Specifically, example 400 shows a topic list 401 generated for a presentation on World War 2. As explained above in FIG. 3, the prepared presentation evaluation MLM 112 may generate a respective presentation score 403 and the prepared engagement evaluation MLM 114 may generate a respective individual engagement score 405 each separate topic in the topic list 401. Accordingly, the scoring engine 120 may generate a presentation score 403, an engagement score 405, and/or comprehension score 407 for each separate topic in the topic list. This systematic scoring approach allows for precise evaluation of presentation effectiveness, audience engagement, and topic comprehension across various subject areas.

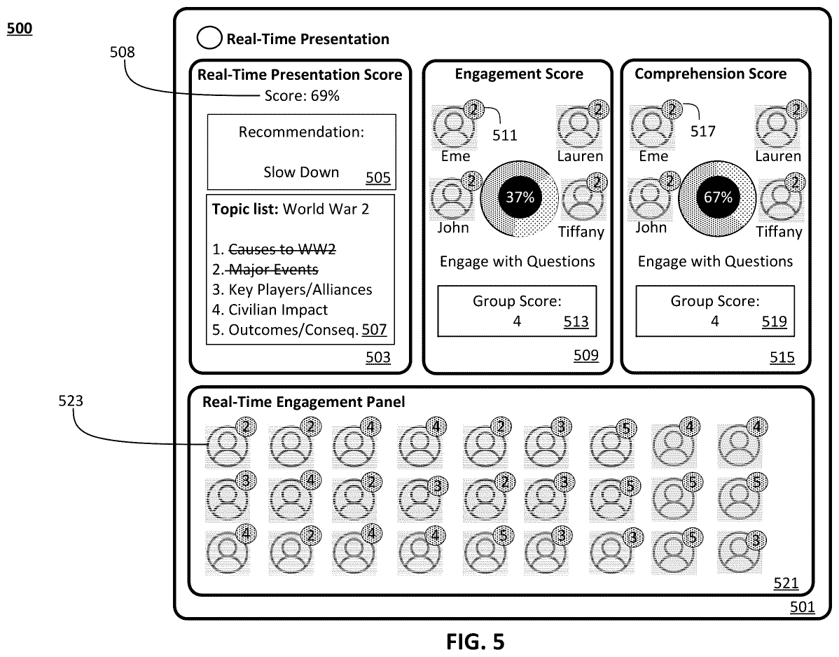

FIG. 5 is an example of a user interface 501 for presenting real-time scores and recommendations for presenters and audience members according to aspects of the present disclosure.

As shown in example 500, the UI 501 includes a real-time presentation panel 503 that shows a real-time presentation score 508, a real-time presenter recommendation 505, and an optional topic list 507, a real-time engagement panel 509 that shows a real-time individual engagement score 511 for each audience member and an overall group engagement score 513, a real-time comprehension score panel 515 that shows a real-time comprehension score 517 an a group comprehension score 519, and a real-time engagement panel 521 that shows each audience member and a corresponding real-time engagement score 523.

It will be understood by those skilled in the art that the specific UI elements and layout in the UI 501 is not limited to example 500. The technical solution according to the present disclosure may include more or fewer panels and/or UI elements.

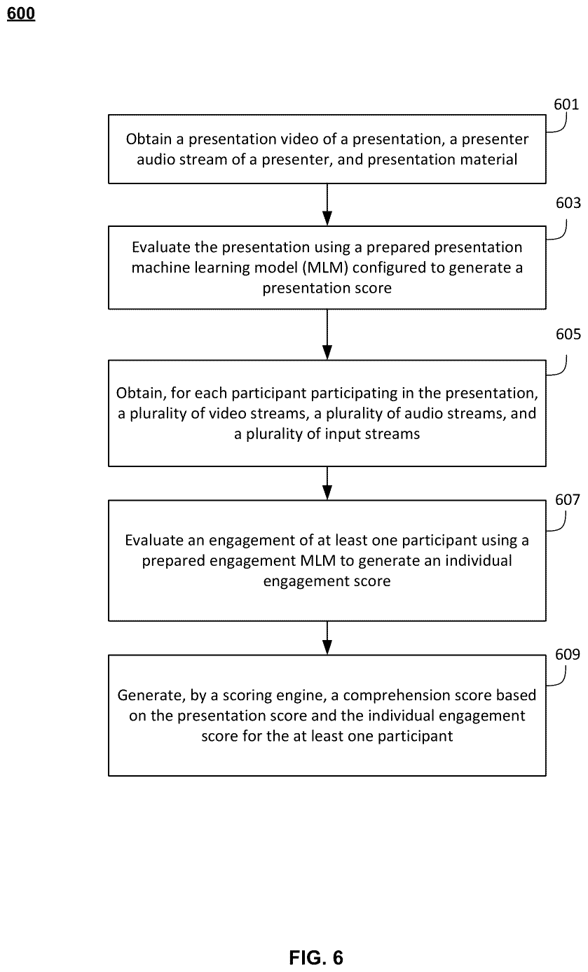

FIG. 6 is an example method for a machine-learning (ML)-based assessment of a presentation by a presenter and engagement of audience members according to an aspect of the present disclosure. In various implementations, the method 600 is performed by a device with one or more processors and non-transitory memory that performs intent prediction. In some implementations, the method 600 is performed by processing logic, including hardware, firmware, software, or a combination thereof. In some implementations, the method 600 is performed by a processor executing code stored in a non-transitory computer-readable medium (e.g., a memory). The method 600 describes a method for assessing a presentation and engagement of the presentation by audience members.

At 601, the method 600 may include obtaining a presentation video stream of a presentation, a presenter audio stream of a presenter, and presentation material. As an example, referring back to FIG. 1, the collection module 108 may obtain the presentation video stream from the camera 103 of the presenter 101, the audio stream from a microphone 105 of the presenter and presentation material 102.

At 603, the method 600 may include evaluating the presentation using a prepared presentation evaluation MLM configured to generate a presentation score based on the presentation video stream, the presenter audio stream, and the presentation material. As an example, referring back to FIGS. 1-3, the prepared presentation evaluation MLM 112 may generate a presentation score based on the presentation video stream from the camera 103, the presenter audio stream from a microphone 105, and the presentation material 102.

In some aspects, the method 600 may include: preparing the presentation evaluation MLM by: (1) providing, to the presentation evaluation MLM, a presentation training dataset comprising at least one of: (a) presenter video streams of presenters presenting a presentation labeled and annotated with quality scores for clarity, engagement, accuracy, or content delivery to evaluate at least one of body language, gestures, facial expressions, or visual aids of the presenter, (b) corresponding audio streams labeled and annotated for features of at least one of voice quality, pauses, tone, or fluency to analyze speech delivery, clarity, tone, or impact of the presenter, (c) presentation material aligned with the labeled presenter video streams labeled and annotated to assess at least one of content quality, relevance, or alignment between the presentation and the presentation materials, and (d) ground truth labels for the presenter video streams, the corresponding audio streams, or the presentation material to serve as a target output for the presentation evaluation MLM model; and (2) preparing the presentation evaluation MLM using the presentation training dataset. As an example, referring back to FIGS. 1-2, the MLM training module 118 may train and/or prepare the presentation evaluation MLM 112.

At 605, the method 600 may include obtaining, for each audience member participating in the presentation, a plurality of video streams capturing each respective audience member, a plurality of audio streams for each respective audience member, and a plurality of capture streams capturing an interaction of each audience member and a respective computing device. As an example, referring back to FIGS. 1 and 3, the collection module 108 may obtain, for each audience member 107a, 107b, 107n, a plurality of video streams from cameras 109a, 109b, 109n capturing each respective audience member 107a, 107b, 107n, a plurality of audio streams from microphones 113a, 113b, 113n for each respective audience member 107a, 107b, 107n, and a plurality of capture streams from the computing devices 111a, 111b, 111n capturing an interaction of each audience member 107a, 107b, 107n and a respective computing device 111a, 111b, 111n.

At 607, the method 600 may include evaluating an engagement of at least one audience member using a prepared engagement evaluation MLM configured to generate an individual engagement score for the at least one audience member based on the plurality of video streams, the plurality of audio streams, and the plurality of capture streams. As an example, referring back to FIGS. 1-3, a prepared engagement evaluation MLM 114 may be configured to generate an individual engagement score for at least one audience member based on the plurality of video streams, the plurality of audio streams, and the plurality of capture streams.

In some aspects, the method 600 may include: preparing the engagement evaluation MLM by: (1) providing, to the engagement evaluation MLM, an engagement training dataset comprising at least one of: (a) individual video streams of audience members of a presentation labeled and annotated with facial expressions, gaze direction, body posture, or head movement to capture visual engagement cues, (b) corresponding audio streams labeled and annotated with speech activity, tone analysis, interruptions and pauses, or emotion detection to analyze participation through voice contribution and tone of speech, (c) capture streams of the audience members comprising at least one of keyboard input, mouse movements, or screen interactions, wherein the capture streams are labeled and annotated with active engagement, passive behavior, or multitasking to measure interaction of the audience members with a respective computing device, (d) an event list comprises at least one of interaction events, participation events, attention-related events, engagement-related events, time-based events, or behavioral and biometric events annotated with engagement levels, activity frequency, or contribution quality to capture session-specific events that indicate audience member engagement, and (e) ground truth labels for the individual video streams, the corresponding audio streams, the capture streams, or the event list to serve as a target output for the engagement evaluation MLM; and (2) preparing the engagement evaluation MLM using the provided engagement training dataset. As an example, referring back to FIGS. 1-2, the MLM training module 118 may train and/or prepare the engagement MLM 114.

At 609, the method 600 may include generating, by a scoring engine, a comprehension score based at least in part on the presentation score and the individual engagement score for the at least one audience member. As an example, referring back to FIGS. 1 and 3-4, the scoring engine 120 may generate a group comprehension score 519 based at least in part on the presentation score 508 and the real-time individual engagement score 511.

In some aspects, the method 600 may include evaluating a group engagement of audience members for the presentation by generating, using the score engine, a group engagement score based on a plurality of engagement scores for each audience member participating in the presentation. As an example, referring back to FIGS. 1 and 3-4, the scoring engine 120 may generate an overall group engagement score 513 based on the plurality of real-time individual engagement scores 511 for each audience member.

In some aspects, the method 600 may include, based on the comprehension score, an output of the prepared presentation evaluation MLM, and an output of the prepared engagement evaluation MLM, generating, by a recommendation engine, a real-time presenter recommendation or a real-time audience member recommendation, and displaying, on a display, at least one of the real-time presenter recommendation, the real-time audience member recommendation, the comprehension score, the presentation score, or the individual engagement score for the at least one audience member. As an example, referring back to FIGS. 1-4, the optional recommendation engine 122 may be configured to output a real-time presenter recommendation 505 and/or a real-time audience member recommendation and display the recommendation on a UI 501.

In some aspects, the real-time presenter recommendation may include at least one of: ask a question, introduce a poll or quiz, call on an audience member, acknowledge contribution of an audience member, slow down, speed up, repeat material, summarize material, present a visual aid, or introduce a break. In some aspects, the real-time audience member recommendation may include at least one of: take notes, ask questions, respond to prompts, use non-verbal feedback, participate in chat, adjust computing environment, or change physical posture.

In some aspects, the method 600 may further include generating, by a recommendation engine, and displaying, on a display, a post-presentation presenter recommendation or a post-presentation audience member recommendation based on outputs of the prepared presentation MLM and the prepared engagement evaluation MLM. In some aspects, the post-presentation presenter recommendation comprises at least one of: changing content of the presentation, changing speech for the presentation, or changing activities of the presentation. In some aspects, the post-presentation audience member recommendation comprises at least one of: assigning additional reading, recommendation to watch video of the presentation, request participation in subsequent lectures, or assign a quiz.

In some aspects, the method 600 may further include: identifying a subject matter for the presentation and recognizing topics for the presentation using a topic MLM configured to determine main topics of the presentation based on the lecture material; evaluating the presentation of each topic of the presentation using the prepared presentation evaluation MLM configured to generate a respective presentation score for each topic based on the subject matter, recognized topic, presentation video stream, the presenter audio stream, and the presentation material; and evaluating the engagement of at least one audience member for each topic of the presentation using the prepared engagement evaluation MLM configured to generate a respective engagement score of the at least one audience member for each topic based on the subject matter, the recognized topic, the plurality of video streams, the plurality of audio streams, and the plurality of capture streams. As an example, referring back to FIGS. 1 and 4, an optional prepared topic determination MLM 116 may be configured to determine that the topic list 401 for World War 2 include: (1) causes to WW2, (2) major events, (3) key players/alliances, (4) civilian impact, and (5) outcomes/consequences.

In some aspects, the method 600 may further include: preparing the topic MLM by: (1) providing, to the topic MLM, a topic training dataset comprising at least one of: (a) presentation materials labeled and annotated with subject matter, key topics, or keywords and phrases to extract and analyze a textual and visual content of the presentation to infer the subject matter and individual topics, (b) topic labeled datasets comprising at least domain-specific data labeled and annotated with subject matter tags and topics to train the topic MLM to recognize subject matter and topics, (c) audio and video presentation data comprising at least presentation recordings and corresponding audio streams labeled and annotated with subject matter and topics to identify spoken words, tone, and context for recognizing topics, and (d) ground truth labels for the presentation materials, topic labeled datasets, or audio and video presentation data to serve as a target output for the topic MLM; and (2) preparing the topic MLM using the provided topic training dataset. As an example, referring back to FIGS. 1-2, a MLM training module 118 may train and/or prepare the optional topic determination 116.

In some aspects, the method 600 may further comprise evaluating a group engagement of audience members for each topic of the presentation using the prepared engagement evaluation MLM configured to generate a respective group engagement score of audience members for each topic based on the subject matter, the recognized topic, the plurality of video streams, the plurality of audio streams, and the plurality of capture streams.

FIG. 7 presents an example of a general-purpose computer system on which aspects of the present disclosure can be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for machine-learning (ML)-based assessment of a presentation by a presenter and engagement of audience members, comprising:
obtaining a presentation video stream of a presentation, a presenter audio stream of a presenter, and presentation material;
evaluating the presentation using a prepared presentation evaluation machine learning model (MLM) configured to generate a presentation score based on the presentation video stream, the presenter audio stream, and the presentation material;
obtaining, for each audience member participating in the presentation, a plurality of video streams capturing each respective audience member, a plurality of audio streams for each respective audience member, and a plurality of capture streams capturing an interaction of each audience member and a respective computing device;
evaluating an engagement of at least one audience member using a prepared engagement evaluation MLM configured to generate an individual engagement score for the at least one audience member based on the plurality of video streams, the plurality of audio streams, and the plurality of capture streams; and
generating, by a scoring engine, a comprehension score based at least in part on the presentation score and the individual engagement score for the at least one audience member.

2. The method of claim 1, further comprising:
based on the comprehension score, an output of the prepared presentation evaluation MLM, and an output of the prepared engagement evaluation MLM, generating, by a recommendation engine, a real-time presenter recommendation or a real-time audience member recommendation; and
displaying, on a display, at least one of the real-time presenter recommendation, the real-time audience member recommendation, the comprehension score, the presentation score, or the individual engagement score for the at least one audience member.

3. The method of claim 2, wherein the real-time presenter recommendation comprises at least one of: ask a question, introduce a poll or quiz, call on an audience member, acknowledge contribution of an audience member, slow down, speed up, repeat material, summarize material, present a visual aid, or introduce a break,
wherein the real-time audience member recommendation comprises at least one of: take notes, ask questions, respond to prompts, use non-verbal feedback, participate in chat, adjust computing environment, or change physical posture.

4. The method of claim 1, further comprising:
identifying a subject matter for the presentation and recognizing topics for the presentation using a topic MLM configured to determine main topics of the presentation based on the presentation material;
evaluating the presentation of each topic of the presentation using the prepared presentation evaluation MLM configured to generate a respective presentation score for each topic based on the subject matter, recognized topic, presentation video stream, the presenter audio stream, and the presentation material; and
evaluating the engagement of at least one audience member for each topic of the presentation using the prepared engagement evaluation MLM configured to generate a respective engagement score of the at least one audience member for each topic based on the subject matter, the recognized topic, the plurality of video streams, the plurality of audio streams, and the plurality of capture streams.

5. The method of claim 1, further comprising:
evaluating a group engagement of audience members for the presentation by generating, using the score engine, a group engagement score based on a plurality of engagement scores for each audience member participating in the presentation.

6. The method of claim 4, further comprising:
evaluating a group engagement of audience members for each topic of the presentation using the prepared engagement evaluation MLM configured to generate a respective group engagement score of audience members for each topic based on the subject matter, the recognized topic, the plurality of video streams, the plurality of audio streams, and the plurality of capture streams.

7. The method of claim 1, further comprising preparing the presentation evaluation MLM by:
(1) providing, to the presentation evaluation MLM, a presentation training dataset comprising at least one of:
(a) presenter video streams of individuals giving a presentation labeled and annotated with quality scores for clarity, engagement, accuracy, or content delivery to evaluate at least one of body language, gestures, facial expressions, or visual aids of the presenter,
(b) corresponding audio streams labeled and annotated for features of at least one of voice quality, pauses, tone, or fluency to analyze speech delivery, clarity, tone, or impact of the presenter,
(c) presentation material aligned with the labeled presenter video streams labeled and annotated to assess at least one of content quality, relevance, or alignment between the presentation and the presentation materials, and
(d) ground truth labels for the presenter video streams, the corresponding audio streams, or the presentation material to serve as a target output for the presentation evaluation MLM model; and
(2) preparing the presentation evaluation MLM using the presentation training dataset.

8. The method of claim 1, further comprising preparing the engagement evaluation MLM by:
(1) providing, to the engagement evaluation MLM, an engagement training dataset comprising at least one of:
(a) individual video streams of audience members of a presentation labeled and annotated with facial expressions, gaze direction, body posture, or head movement to capture visual engagement cues,
(b) corresponding audio streams labeled and annotated with speech activity, tone analysis, interruptions and pauses, or emotion detection to analyze participation through voice contribution and tone of speech,
(c) capture streams of the audience members comprising at least one of keyboard input, mouse movements, or screen interactions, wherein the capture streams are labeled and annotated with active engagement, passive behavior, or multitasking to measure interaction of the audience members with a respective computing device,
(d) an event list comprises at least one of interaction events, participation events, attention-related events, engagement-related events, time-based events, or behavioral and biometric events annotated with engagement levels, activity frequency, or contribution quality to capture session-specific events that indicate audience member engagement, and
(e) ground truth labels for the individual video streams, the corresponding audio streams, the capture streams, or the event list to serve as a target output for the engagement evaluation MLM; and
(2) preparing the engagement evaluation MLM using the provided engagement training dataset.

9. The method of claim 4, further comprising preparing the topic MLM by:
(1) providing, to the topic MLM, a topic training dataset comprising at least one of:
(a) presentation materials labeled and annotated with subject matter, key topics, or keywords and phrases to extract and analyze a textual and visual content of the presentation to infer the subject matter and individual topics,
(b) topic labeled datasets comprising at least domain-specific data labeled and annotated with subject matter tags and topics to train the topic MLM to recognize subject matter and topics,
(c) audio and video presentation data comprising at least presentation recordings and corresponding audio streams labeled and annotated with subject matter and topics to identify spoken words, tone, and context for recognizing topics, and
(d) ground truth labels for the presentation materials, topic labeled datasets, or audio and video presentation data to serve as a target output for the topic MLM; and
(2) preparing the topic MLM using the provided topic training dataset.

10. The method of claim 1, further comprising:
generating, by a recommendation engine, and displaying, on a display, a post-presentation presenter recommendation or a post-presentation audience member recommendation based on outputs of the prepared presentation MLM and the prepared engagement evaluation MLM.

11. The method of claim 10, wherein the post-presentation presenter recommendation comprises at least one of: changing content of the presentation, changing speech for the presentation, or changing activities of the presentation.

12. The method of claim 10, wherein the post-presentation audience member recommendation comprises at least one of: assigning additional reading, recommendation to watch video of the presentation, request participation in subsequent presentations, or assign a quiz.

13. A system for machine-learning (ML)-based assessment of a presentation and engagement for an audience member, comprising:
at least one memory; and
at least one hardware processor coupled with the at least one memory and configured, individually or in combination, to:
obtain a presentation video stream of a presentation, a presenter audio stream of a presenter, and presentation material;
evaluate the presentation using a prepared presentation evaluation machine learning model (MLM) configured to generate a presentation score based on the presentation video stream, the presenter audio stream, and the presentation material;
obtain, for each audience member participating in the presentation, a plurality of video streams capturing each respective audience member, a plurality of audio streams for each respective audience member, and a plurality of capture streams capturing an interaction of each audience member and a respective computing device;
evaluate an engagement of at least one audience member using a prepared engagement evaluation MLM configured to generate an individual engagement score for the at least one audience member based on the plurality of video streams, the plurality of audio streams, and the plurality of capture streams; and
generate, by a scoring engine, a comprehension score based at least in part on the presentation score and the individual engagement score for the at least one audience member.

14. The system of claim 13, wherein the at least one hardware processor coupled with the at least one memory and configured, individually or in combination, to:
based on the comprehension score, an output of the prepared presentation evaluation MLM, and an output of the prepared engagement evaluation MLM, generate, by a recommendation engine, a real-time presenter recommendation or a real-time audience member recommendation; and
display, on a display, at least one of the real-time presenter recommendation, the real-time audience member recommendation, the comprehension score, the presentation score, or the individual engagement score for the at least one audience member.

15. The system of claim 14, wherein the real-time presenter recommendation comprises at least one of: ask a question, introduce a poll or quiz, call on an audience member, acknowledge contribution of an audience member, slow down, speed up, repeat material, summarize material, present a visual aid, or introduce a break,
wherein the real-time audience member recommendation comprises at least one of: take notes, ask questions, respond to prompts, use non-verbal feedback, participate in chat, adjust computing environment, or change physical posture.

16. The system of claim 13, wherein the at least one hardware processor coupled with the at least one memory and configured, individually or in combination, to:
identify a subject matter for the presentation and recognizing topics for the presentation using a topic MLM configured to determine main topics of the presentation based on the presentation material;
evaluate the presentation of each topic of the presentation using the prepared presentation evaluation MLM configured to generate a respective presentation score for each topic based on the subject matter, recognized topic, presentation video stream, the presenter audio stream, and the presentation material; and
evaluate the engagement of at least one audience member for each topic of the presentation using the prepared engagement evaluation MLM configured to generate a respective engagement score of the at least one audience member for each topic based on the subject matter, the recognized topic, the plurality of video streams, the plurality of audio streams, and the plurality of capture streams.

17. The system of claim 13, wherein the at least one hardware processor coupled with the at least one memory and configured, individually or in combination, to:
evaluate a group engagement of audience members for the presentation by generating, using the score engine, a group engagement score based on a plurality of engagement scores for each audience member participating in the presentation.

18. The system of claim 13, wherein the at least one hardware processor coupled with the at least one memory and configured, individually or in combination, to:
(1) provide, to the presentation evaluation MLM, a presentation training dataset comprising at least one of:
(a) presenter video streams of presenters presenting a presentation labeled and annotated with quality scores for clarity, engagement, accuracy, or content delivery to evaluate at least one of body language, gestures, facial expressions, or visual aids of the presenter,
(b) corresponding audio streams labeled and annotated for features of at least one of voice quality, pauses, tone, or fluency to analyze speech delivery, clarity, tone, or impact of the presenter,
(c) presentation material aligned with the labeled presenter video streams labeled and annotated to assess at least one of content quality, relevance, or alignment between the presentation and the presentation materials, and
(d) ground truth labels for the presenter video streams, the corresponding audio streams, or the presentation material to serve as a target output for the presentation evaluation MLM model; and
(2) prepare the presentation evaluation MLM using the presentation training dataset.

19. The system of claim 13, wherein the at least one hardware processor coupled with the at least one memory and configured, individually or in combination, to:
(1) provide, to the engagement evaluation MLM, an engagement training dataset comprising at least one of:
(a) individual video streams of audience members of a presentation labeled and annotated with facial expressions, gaze direction, body posture, or head movement to capture visual engagement cues,
(b) corresponding audio streams labeled and annotated with speech activity, tone analysis, interruptions and pauses, or emotion detection to analyze participation through voice contribution and tone of speech,
(c) capture streams of the audience members comprising at least one of keyboard input, mouse movements, or screen interactions, wherein the capture streams are labeled and annotated with active engagement, passive behavior, or multitasking to measure interaction of the audience members with a respective computing device,
(d) an event list comprises at least one of interaction events, participation events, attention-related events, engagement-related events, time-based events, or behavioral and biometric events annotated with engagement levels, activity frequency, or contribution quality to capture session-specific events that indicate audience member engagement, and
(e) ground truth labels for the individual video streams, the corresponding audio streams, the capture streams, or the event list to serve as a target output for the engagement evaluation MLM; and
(2) prepare the engagement evaluation MLM using the provided engagement training dataset.

20. A non-transitory computer readable medium storing thereon computer executable instructions for machine-learning (ML)-based assessment of a presentation and engagement for an audience member, including instructions for:
obtaining a presentation video stream of a presentation, a presenter audio stream of a presenter, and presentation material;
evaluating the presentation using a prepared presentation evaluation machine learning model (MLM) configured to generate a presentation score based on the presentation video stream, the presenter audio stream, and the presentation material;
obtaining, for each audience member participating in the presentation, a plurality of video streams capturing each respective audience member, a plurality of audio streams for each respective audience member, and a plurality of capture streams capturing an interaction of each audience member and a respective computing device;
evaluating an engagement of at least one audience member using a prepared engagement evaluation MLM configured to generate an individual engagement score for the at least one audience member based on the plurality of video streams, the plurality of audio streams, and the plurality of capture streams; and
generating, by a scoring engine, a comprehension score based at least in part on the presentation score and the individual engagement score for the at least one audience member.
